(19) United States
(12) Patent Application Publication
(10) Pub. No.: US 2004/0189848 A1
(43) Pub. Date: Sep. 30, 2004

(54) Operation apparatus and device for image-taking

(76) Inventors: Takeshi Idemura, Saitama (JP); Kentaro Takano, Tokyo (JP)

Correspondence Address: MORGAN & FINNEGAN, L.L.P., 345 PARK AVENUE, NEW YORK, NY, 10154, US

(21) Appl. No.: 10/804,333

(22) Filed: Mar. 18, 2004

(30) Foreign Application Priority Data
Mar. 26, 2003 (JP) 2003-085770

(51) Int. Cl. H04N 5/222

(52) U.S. Cl. 348/333.01

(57) ABSTRACT

A operation apparatus which enables instantly grasping an information concerning a function of the device and setting the function easily is disclosed. The operation apparatus which is used with a device for image-taking; comprises a display member which displays an information concerning a function of the device and a first operation switch for setting the function according to the information displayed on the display member.

### BACKGROUND OF THE INVENTION

1. Field of the Invention

The present invention relates to a operation apparatus which can be used for television image-taking, or the like. Furthermore, the present invention relates to a device for image-taking having the operation apparatus.

2. Description of the Related Art

The image-taking system, which can be used for television image-taking, comprises a television camera and a television lens apparatus, and the image-taking system can be used by attaching the television lens apparatus on the television camera.

The television lens apparatus is roughly divided into a lens main body and a drive unit. On the lens main body, there are provided an image-taking optical system and a manual ring for a manual operation.

Furthermore, a motor for electrically driving the manual ring, a control board, and a CPU are provided inside the drive unit. On the external packaging surface of the drive unit, various kinds of switches for giving an electromotive instruction and an operation members are provided.

With respect to the image-taking by using the television lens apparatus, zooming operation and iris operation are almost performed by manual operation. However, the image-taking by means of electromotive servo is frequently conducted quite recently. Various functions are added to the drive unit. For example, there are provided such functions as a preset function in which the lens is driven to a zooming position which is memorized by pressing a switch when an arbitrary zooming position is once memorized, and a function which enables users to select the switch which the user prefers out of a plurality of switches provided on the drive unit as the switch for setting the preset function.

In the conventional television lens apparatus, in order to set such various functions, a dip switch is provided inside the drive unit. That is, camera man detaches a rubber cap provided on the external surface of the drive unit in accordance with the image-taking situation and operates the dip switch. Therefore, the above described functions can be set.

The above described functions widen a width of the image-taking conducted by a camera man and enables realizing an optimal camera work in accordance with various image-taking situation.

Furthermore, as a television lens apparatus the type of which is different from the type of the above described television lens apparatus, there is a box-type television lens apparatus in which an image-taking optical system and an electromotive drive unit for electrically driving the image-taking optical system are incorporated.

A controller for operating the electromotive drive unit and the box-type television lens apparatus are connected via a cable. A zooming operation is conducted by operating an operation ring on a zoom controller connected with the box-type television lens apparatus when a camera man conducts zooming. At that time, a zooming speed in accordance with a tilt angle of the operation ring is represented in the form of a zooming curve, and the curve characteristics of the zooming curve can be changed by using an operation switch on the zooming controller in accordance with the preference of the user.

However, in the television lens apparatus on which the conventional drive unit is attached, the dip switch for setting the function is provided inside the drive unit, so that the set condition of the function cannot be observed at one view and the rubber cap must be removed for confirming the set condition. Thus, the operationality of the television lens apparatus becomes worse.

In addition, an act of looking at a small dip switch provided inside the drive unit has an insufficient visibility and has a difficulty in instantly understanding the set condition. Furthermore there is a difficulty in operation with respect to an act of changing over the setting by operating the small dip switch with finger tips. In particular, it is extremely difficult to operate a dip switch while confirming the dip switch in an environment with insufficient light.

Furthermore, in a usage environment peculiar to a television lens apparatus in which a plurality of camera men share one set of image-taking equipment, it is very important to easily and instantly understanding the set condition which is previously used by the camera man. With the conventional television lens apparatus, it has been difficult to meet the above described importance. In the television lens apparatus which will become more and more complicated from now on, it is desired that the set condition or the like can be instantly grasped, and setting member excellent in operation can be incorporated.

Furthermore, with respect to the box-type lens, it is required to increase the number of operation switches on the zoom controller more than before in order to meet the demand of users which has come to be diversified. It is feared that the operation becomes more difficult due to the increase in the number of switches and the cost thereof comes high.

### SUMMARY OF THE INVENTION

An object of the present invention is to provide a operation apparatus and a device for image-taking which enable easily grasping an information concerning of the function and is excellent in usability.

One aspect of the operation apparatus which is used with a device for image-taking and is the present invention comprises a display member which displays an information concerning a function of the device and a first operation switch for setting the function according to the information displayed on the display member.

One aspect of the device for image-taking, comprises the above described operation apparatus and an optical adjusting member.

Another aspect of the device for image-taking, comprises a lens apparatus having an optical adjusting member and a drive unit for driving the optical adjusting member. Here, a display member which displays an information concerning a function of the lens apparatus, is provided on the lens apparatus, and a first operation switch for setting the function according to the information displayed on the display member, is provided on the drive unit.

The features of the operation apparatus and the device for image-taking which are the present invention will become more apparent from the following detailed description of a preferred embodiment of the invention with reference to the drawings.

### BRIEF DESCRIPTION OF THE DRAWINGS

FIG. 1 is a side view of a television lens apparatus according to Embodiment 1 of the present invention.

FIG. 2 is a back view of the television lens apparatus according to Embodiment 1.

FIG. 3 is an enlarged view of a display panel.

FIG. 4 is an enlarged view of a function setting switch.

FIG. 5 is an enlarged view of the display panel.

FIG. 6 is an enlarged view of the display panel which displays a zooming characteristic.

FIG. 7 is a side view of the television lens apparatus according to Embodiment 2 of the present invention.

FIG. 8 is a back view of the television lens apparatus according to Embodiment 2.

FIG. 9 is an external view of the drive unit according to Embodiment 3 of the present invention.

FIG. 10 is a side view of the television lens apparatus according to Embodiment 4 of the present invention.

FIG. 11 is a side view of the television lens apparatus according to Embodiment 5 of the present invention.

FIG. 12 is a back view of the television lens apparatus according to Embodiment 5.

FIG. 13 is a diagram showing a condition in which the box-type lens apparatus according to Embodiment 6 of the present invention is used.

FIG. 14 is an external perspective view of the television lens apparatus according to Embodiment 7 of the present invention.

FIG. 15 is an external perspective view of the box-type television lens apparatus according to Embodiment 7.

FIG. 16 is a diagram showing a condition in which the box-type television lens apparatus according to Embodiment 7.

### PREFERRED EMBODIMENT OF THE INVENTION

With reference now to the attached drawings, a television lens apparatus which is embodiments of the present invention will be explained in detail below.

### Embodiment 1

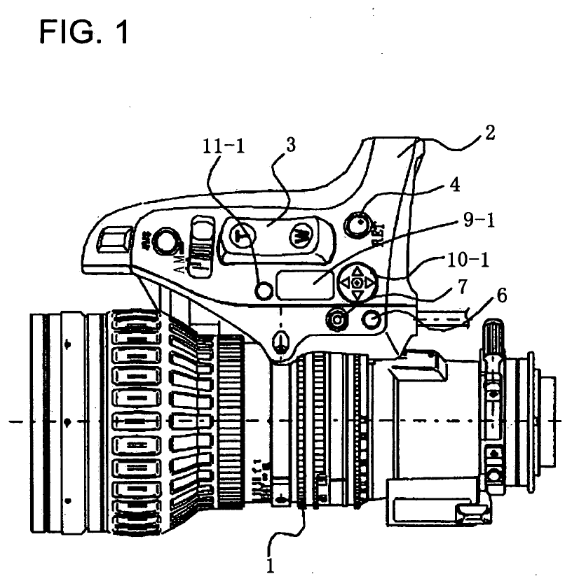

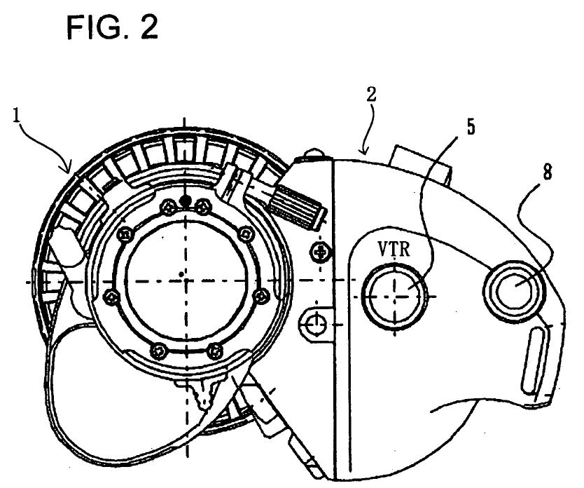

A television lens apparatus according to Embodiment 1 of the present invention will be explained in detail on the basis of the drawings. FIGS. 1 and 2 are external views of the television lens apparatus.

In FIGS. 1 and 2, numeral 1 denotes a lens main body (device for image-taking). An image-taking optical system (optical adjusting member) is provided inside the lens main body 1 and a manual ring for manually performing the focusing operation, a zooming operation and an iris driving is provided on the lens main body 1.

Numeral 2 denotes a drive unit (operation apparatus) which is detachably attached on the lens main body 1. A motor (not shown) for electrically driving the manual ring, a control board, a CPU and a like are provided inside the drive unit 2.

Numeral 3 denotes a seesaw switch (second operation switch) which is operated when the zooming operation is performed by driving the lens main body 1. When the “T” area or the “W” area of the seesaw switch 3 is pressed in FIG. 1, the focal length of the image-taking optical system is shifted either in the direction of the telephoto-angle or in the direction of the wide-angle by speed in accordance with the press amount.

Numeral 4 denotes a return switch for sending back the signal to the camera (not shown) in accordance with the operation of the switch. Furthermore, numeral 5 shown in FIG. 2 shows a VTR switch which serves as a trigger of recording the image data.

When the camera man holds the drive unit 2 with the right hand, the return switch 4 is normally operated with an index finger and the VTR switch 5 is normally operated with the thumb. These switches, namely, the seesaw switch 3, the return switch 4 and the VTR switch 5 are the most basic switches associated with the television image-taking. From the viewpoint of inheriting the operationality of the television lens apparatus, these switches are arranged at a traditional position shown in FIGS. 1 and 2 as before in the long history of the television lens apparatus.

Numeral 6 denotes a first function switch (third operation switch). One function out of various functions associated with the image-taking by using the television lens apparatus is allocated to the first function switch 6. For example, when the preset function is allocated to the first function switch 6, the current zoom position can be memorized by pressing the first function switch 6 at the same time with the memory switch 7. Thereafter, even if the image-taking optical system (lens) is located at any position, the image-taking optical system can be brought back to the memorized position by pressing the first function switch 6.

Furthermore, numeral 8 shown in FIG. 2 denotes a second function switch (third operation switch). One function out of various functions associated with the image-taking by using the television lens apparatus is allocated to the second function switch 8 as well. For example, when the function of moving the image-taking optical system (lens) in a forward and backward direction is allocated to the second function switch 8, the lens moves to the telephoto end during the operation of the second function switch 8 and focusing operation is performed at the telephoto end having a shallow depth, and then the lens can back to the original position by releasing hand from the second function switch 8. The above-mentioned function can be used as an assistant function for focusing.

On the other hand, it is possible to cause functions corresponding to the switches 6 and 8 to be not carried out even when either the first function switch 6 or the second function switch 8 is pressed so that the switches 6 and 8 are not mistakenly operated to move the lens suddenly when the lens is driven by the manual operation of the camera man.

Numeral 9-1 denotes a liquid crystal display panel (display member) provided on the upper surface of the drive unit 2. Numeral 10-1 denotes a function setting switch (first operation switch) for setting various functions associated with the image-taking by using the television lens apparatus. Numeral 11-1 denotes a display switch. In embodiment 1, the display panel 9-1, the display switch 11-1 and the function setting switch 10-1 are provided on the upper surface of the drive unit 2.

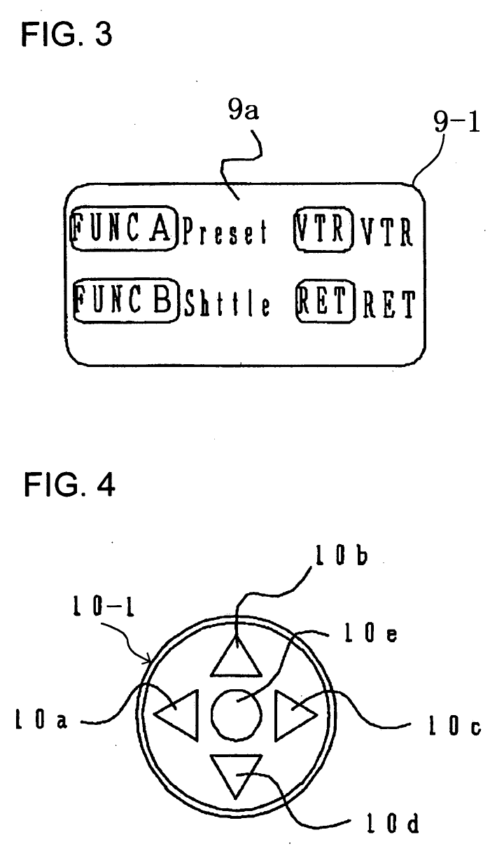

FIGS. 3 and 4 are enlarged views of the display panel 9-1 and the function setting switch 10-1. In FIG. 3, one example of the display surface 9a of the display panel 9-1 shows as to which function is allocated to each switch of the drive unit 2.

In FIGS. 3, “FUNC A” shows the function allocated to the first function switch 6, “FUNC B” shows the function allocated to the second function switch 8. Here, the preset function (Preset) and the forward and backward movement function (Shuttle) are allocated to the FUNC A and FUNC B respectively.

The functions can be allocated to the VTR switch 5 and the return switch 4. In this embodiment, the original functions of the switches 5 and 4 are set. The user can confirm the current set condition of the switches 4, 5, 6, and 8 by observing the display panel 9-1.

Allocating the each function to each switch of switches 4, 5, 6 and 8 is performed by operating the function setting switch 10-1 shown in FIG. 4. The function setting switch 10-1 comprises four arrow keys 10a to 10d and one set key 10e as shown in FIG. 4. The cursor can be moved along the hierarchial menu displayed on the display panel 9-1 by operating any arrow key of four arrow keys 10a to 10d so that one of the plurality of functions is selected. And the selected function can be set by operating the set key 10e.

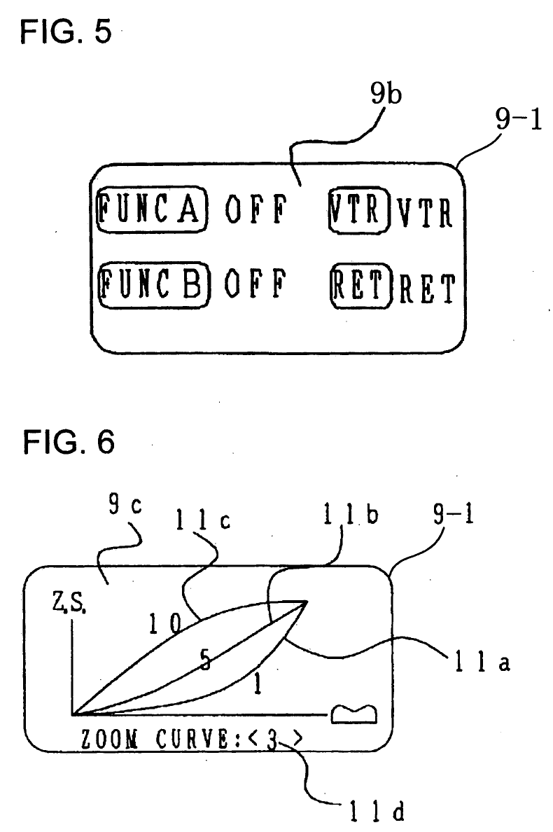

FIG. 5 shows a display content 9b of the display panel 9-1 different from the display content shown in FIG. 3.

That is, FIG. 5 shows one display example when no function is allocated to the first function switch 6 and the second function switch 8 by using the function setting switch 10-1 for the prevention of a wrong operation of the switch. In FIG. 5, “FUNC A” and “FUNC B” are in a OFF state. By using the display panel 9-1 and the function setting switch 10-1 in combination with each other, the function associated with the lens movement can be set with respect to the switches 4, 5, 6 and 8 and can be confirmed in a plain manner.

Furthermore, in this embodiment, the display panel 9-1 and the function setting switch 10-1 are arranged on the same surface (outer surface) of the drive unit 2 and are close to each other. Therefore, it is possible to assure the visibility and the operationality for setting the function of the switches 4, 5, 6 and 8. The display switch 11-1 shown in FIG. 1 is the switch for turning on (display state), and off (non-display state), the display of the display panel 9-1. The display panel 9-1 is caused to be in a display state by operating the display switch 11-1 only when required, thereby the power consumption can be decreased.

FIG. 6 shows a display content of the display panel 9-1 when the characteristic of the seesaw switch 3 which is operated to perform the electromotive zooming operation is set. In the electromotive zooming operation, the zoom speed changes in accordance with the pressed amount of the seesaw switch 3. When the pressed amount is maximized, the zoom speed becomes maximum. On the other hand, when the pressed amount becomes small gradually, the zoom speed is decreased. The camera man can confirm the relationship between the pressed amount of the seesaw switch 3 and the zoom speed through the display of the display panel 9-1 and can change the above described relationship by operating the function setting switch 10-1.

On the display screen of the display panel 9-1 shown in FIG. 6, the horizontal axis shows the pressed amount of the seesaw switch 3 and the vertical axis shows the zoom speed. The representative three relationships between the pressed amount of the seesaw switch 3 and the zoom speed are displayed with three curves (zoom curves) 11a, 11b and 11c respectively. Here, the zoom curve 11a makes much account of the slow characteristics of the zoom. When the seesaw switch 3 is operated, the zooming operation is started in a mild manner. Since the change amount of zoom speed in a low speed area (leftward area in FIG. 6) of the zoom curve 11a is small, the setting of a fine zoom speed can be easily performed. On the other hand, the zoom curve 11c makes much account of the high speed characteristics of the zoom. Here, when the operation of the seesaw switch 3 is started, the zoom speed is abruptly increased, but the change amount of zoom speed becomes small closer to the maximum speed. Therefore, the zoom speed in a high speed area (rightward area in FIG. 6) of the zoom curve 11c can be easily set.

The zoom curve 11b is situated in the intermediate between the zoom curves 11a and 11c. A display area 11d is an area for inputting the numerals for setting the zoom characteristics. If the characteristic of zoom curve 11a is set to 1, the characteristic of zoom curve 11b is set to 5 and the characteristic of zoom curve 11c is set to 10, the camera man can select desired numerals out of ten numerals from one to ten by operating the arrow keys 10a and 10c of the function setting switch 10-1, and can set a zoom characteristics corresponding to the selected numerals by pressing the set key 10e.

As described above, the display panel 9-1 and the function setting switch 10-1 which are used to set the function associated with the operation characteristic of the lens are provided on the television lens apparatus (drive unit 2). Therefore, it is no need to remove a rubber cap provided on the drive unit and operate the dip switch provided inside the drive unit in the conventional television lens apparatus.

Furthermore, since the function can be allocated to each switch depending on the display content (for example, a text information) on the display panel 9-1, the function can be set easy and excellent in operationality. And the light of the display panel 9-1 can cause the user to easily confirm the set condition even in a dark environment.

Furthermore, in a usage environment peculiar to the television lens apparatus in which a plurality of camera men share one set of image-taking equipment, the set condition of the television lens apparatus which is set before can be easily and instantly grasped by observing the display of the display panel 9-1. Thus, the danger of causing an unexpected trouble can be avoided when the camera man uses the television lens apparatus without grasping the set condition of the function.

A motor (not shown) for driving the lens of the image-taking optical system and a CPU are provided in the drive unit 2. And the display panel 9-1 and the function setting switch 10-1 are required to be electrically connected with the CPU. In this embodiment, since the display panel 9-1 and the function setting switch 10-1 are provided on the drive unit 2, the wiring which connects the CPU and the display panel 9-1 or the function setting switch 10-1 can be easily provided.

On the other hand, there is the camera man who does not desire that the switches which are not required when manual image-taking, the function setting switch 10-1 and the display panel 9-1 are provided on the television lens apparatus. In this embodiment, the function setting switch 10-1 and the display panel 9-1 are provided on the drive unit 2 which can be detached from the lens main body 1. Therefore, the camera man removes the drive unit 2 from the lens main body 1, and can attach other drive unit, for example, the drive unit for the camera man which performs only manual operation, that is, the drive unit having the required minimum switches with respect to the image-taking, on the lens main body 1. And a television lens apparatus can be constituted in accordance with the specification desired by the camera man only by using the lens main body 1 serving as the common main component and changing the drive unit.

### Embodiment 2

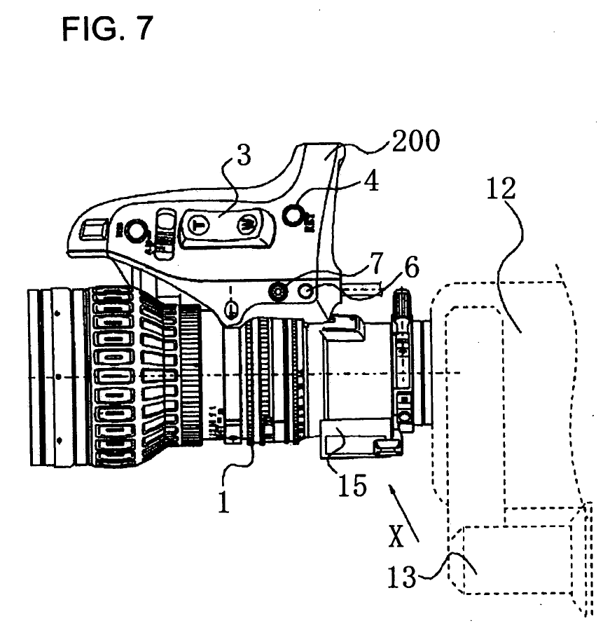

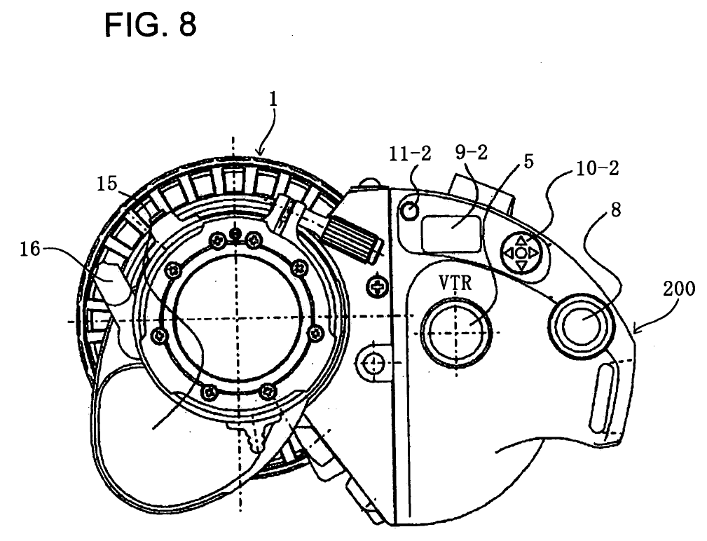

A television lens apparatus which is embodiment 2 of the present invention will be explained in detail on the basis of FIGS. 7 and 8.

FIGS. 7 and 8 are external views of the television lens apparatus, wherein numeral 12 denotes a television camera shown by a broken line. The lens main body 1 is mounted on the television camera 12. The object light which has passed through the image-taking optical system in the lens main body 1 is received by an image-pickup element such as CCD (not shown) which is provided in the television camera 12, and is converted into an electrical signal via the image-pickup element. An image processing circuit (not shown) provided in the television camera 12 performs a predetermined image processing to the electrical signal which is read from the image-pickup element, and then generates an image signal.

In this embodiment, as shown in FIGS. 7 and 8, the display panel 9-2, the display switch 11-2 and the function setting switch 10-2 are provided on the end surface of the drive unit 200 (operation apparatus) on the side of the camera 12.

In the television lens apparatus according to Embodiment 1 which has been described above, the display panel 9-1 and the function setting switch 10-1 are provided on the upper surface of the drive unit 2. On the other hand, in this embodiment, the display panel 9-2 and the function setting switch 10-2 are provided on the end surface of the drive unit 200 on the side of the camera 12. In this embodiment, the arrangement position of the display panel and the function setting switch with respect to the drive unit 200 are different from that of Embodiment 1, and other constitution is the same as Embodiment 1. That is, the functions of the display panel 9-2 and the function setting switch 10-2 according to Embodiment 2 are the same as those of the display panel 9-1 and the function setting switch 10-1 according to Embodiment 1. Furthermore, in FIG. 7 and 8, the constitution parts which are the same as those of the Embodiment 1, are denoted with the same numerals in FIGS. 1 and 2. The display contents of the display panel 9-2 are the same as those of Embodiment 1. Therefore, an explanation thereof is omitted, and only points which are different from embodiment 1 will be explained below.

In this embodiment, the display panel 9-2 and the function setting switch 10-2 are provided on the end surface of the drive unit 200 on the side of the camera as described above. The display panel 9-2 and the function setting switch 10-2 are provided on the end surface of the camera 12 side which is located opposite to the end surface of the object side, therefore, the display light of the display panel 9-2 is not directly applied to the object, and no trouble is caused at the time of the night image-taking which is performed without being noticed by the object.

In the close-up image-taking, it is possible to repress the display light of the display panel 9-2 which is reflected by the object and comes in the television lens apparatus 1 from having influence on the image taken.

Furthermore, in the case where the image-taking is performed out of doors, since the display surface of the display panel 9-2 does not face the upper side of the drive unit 200, it is possible to repress the display content of the display panel 9-2 from becoming difficult to be observed by an external light (for example, a sunlight) reflected on the display surface of the display panel 9-2.

Furthermore, as shown in FIG. 8, the display panel 9-2 and the function setting switch 10-2 are provided on the end face of the camera 12 side in the drive unit 200, thereby the camera man can easily confirm the display content of the display panel 9-2 from the direction of X in FIG. 7 in the state that the camera man looks into the viewfinder 13 of the camera 12. That is, the camera man can easily confirm the display content of the display panel 9-2 while performing the image-taking in the state where the viewfinder 13 is looked into.

Furthermore, the function setting switch 10-2 is provided on the same surface as the VTR switch 5 and is arranged at the upper position of the VTR switch 5. Therefore, it is possible to repress the function setting switch 10-2 from interfering with the operation of the VTR switch 5 and the return switch 4 which are frequently used in the normal image-taking.

In addition, the function switch 10-2 is arranged on the upper side of the VTR switch 5, which causes the finger (for example, the thumb for operating the VTR switch 5 as described above) to difficult to reach the function setting switch 10-2, and it is possible to repress the function setting switch 10-2 from being operated mistakenly.

### Embodiment 3

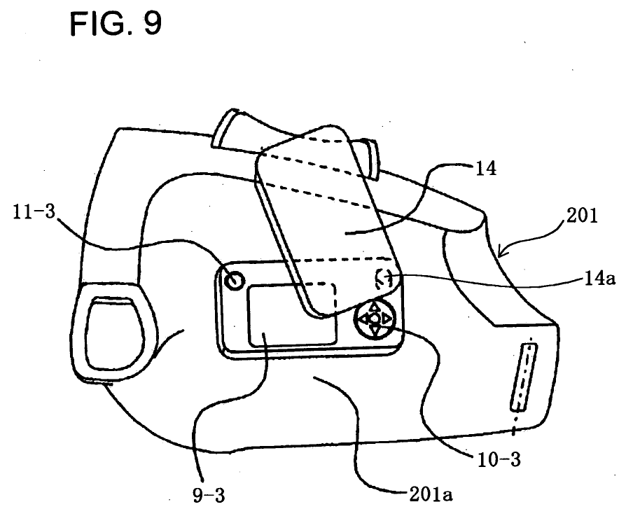

FIG. 9 is a view showing a drive unit 201 (operation apparatus) in Embodiment 3 of the present invention.

In Embodiment 3, the display panel 9-3, the display switch 11-3 and the function setting switch 10-3 are provided on the hold surface 201a for holding the drive unit 201 when supporting the drive unit 201 on the hand. With respect to the arrangement position of the display panel 9-3 and the function setting switch 10-3 and with respect to the structure having a the rubber cover 14, Embodiment 3 is different from each of the embodiments which have been described above.

The rubber cover 14 is supported by the hold surface 201a of the drive unit 201 through a rotation shaft 14a, and can cover the area including the display switch 11-3, display panel 9-3 and the function setting switch 10-3 by rotating around the rotating shaft 14a. The hold surface 201a of the drive unit 201 has an area which is normally held with hands, and an area on which other switches are not provided, so that the arrangement area of the display panel 9-3 is not limited by other switches and a wide display area can be secured.

Furthermore, since the display surface of the display panel 9-3 does not face the object side, the display light of the display panel 9-3 is not applied directly to the object and image-taking can be performed without causing a trouble even at the time of the above described night image-taking in the same manner as Embodiment 2. Furthermore, in the case where the close-up image-taking is performed, the display light of the display panel 9-3 reflected by the object does not have influence on the image taken.

Furthermore, in this embodiment, the display panel 9-3 and the function setting switch 10-3 are covered with the rubber cover 14 when the display panel 9-3 and the function setting switch 10-3 are not used. Therefore, the display panel 9-3 is protected from the collision, rain and dust while repressing erroneous settings by erroneously operating the function setting switch 10-3.

### Embodiment 4

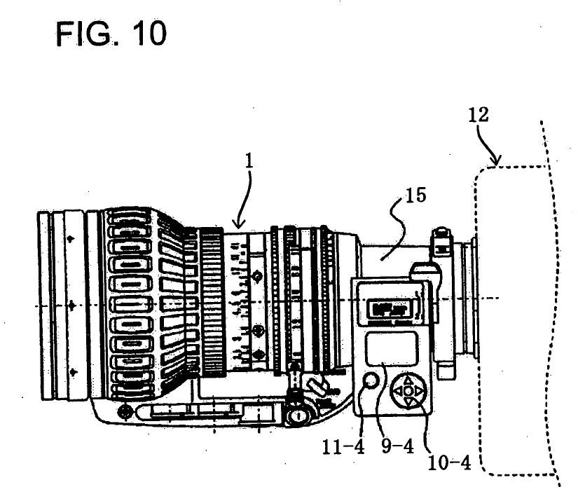

FIG. 10 is a view showing a television lens apparatus which is Embodiment 4 of the present invention.

In Embodiment 4, the display panel 9-4, the display switch 11-4 and the function setting switch 10-4 are provided on an extender box 15 (device for image-taking) of the lens main body 1. In this respect, Embodiment 4 is different from each of the embodiments which have been described above.

Inside the extender box 15, a structure is incorporated for inserting and retracting the magnifying lens (optical adjusting member) of the image-taking optical system in accordance with the operation of the extender lever 16, which normally change over the focal length of the image-taking optical system between two times scale and an equal scale.

As shown in FIG. 10, the extender box 15 is different from the other part of the lens main body 1, that is, at least partial area of the outer surface of the extender box 15 can be formed flat. Therefore, the display panel 9-4 having the planate display surface can be provided on the extender box 15. Then, it is possible to extend the display surface of the display panel 9-4 and make visibility excellent in the display panel 9-4 compared with providing the display panel 9-4 on the outer surface of other part of the lens main body 1.

Furthermore, when the camera man uses (supports) the camera 12 on which the lens main body 1 is mounted, since the face of the camera man is normally placed to the left side of the camera 12 for the object (front side with respect to the space of FIG. 10), a display unit such as a level meter or the like (not shown) is provided on the left side face of the camera 12. In this embodiment, the display panel 9-4 is arranged such that the display surface of the display panel 9-4 faces in the same direction as the display surface of the above described display unit. Therefore, when the camera is supported, the display contents of the above described display unit and the display panel 9-4 can be easily confirmed.

### Embodiment 5

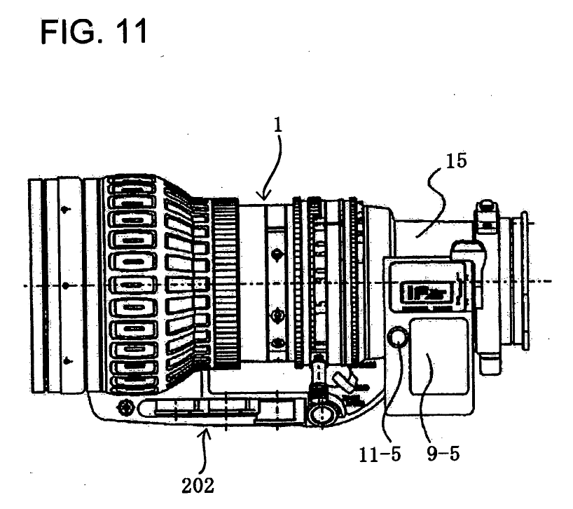

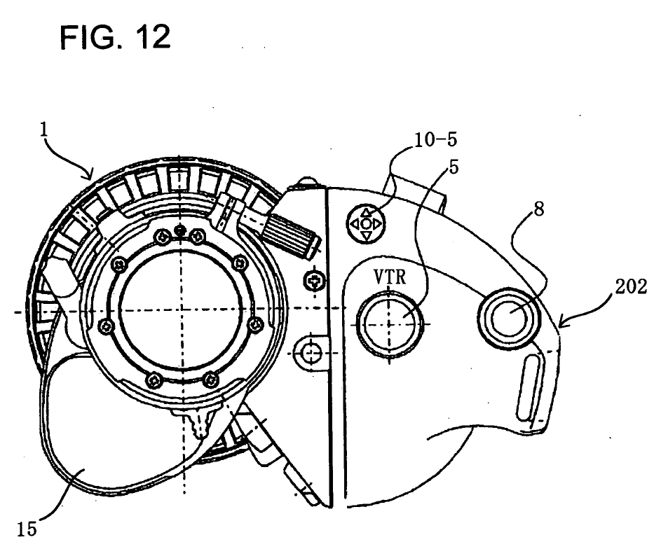

FIGS. 11 and 12 are views showing a television lens apparatus which is Embodiment 5 of the present invention.

In Embodiment 5, the display panel 9-5 and the display switch 11-5 are provided on the extender box 15 and the function setting switch 10-5 is provided on a drive unit 202. In this respect, Embodiment 5 is different from each of the embodiments which have been described above.

According to Embodiment 5, since the function setting switch 10-5 is provided on the drive unit 202, switches including the VTR switch, the first function switch 8 and the function setting switch 10-5 or the like can be provided together with one another on the drive unit. Thus, all of the switches can be operated in the drive unit 202, and the user friendly television lens apparatus can be realized.

Furthermore, in this embodiment, since the function setting switch 10-5 is provided on the drive unit 202 and the display panel 9-5 is provided on the extender box 15, it is possible to enlarge the arrangement space of the display panel 9-5 in the extender box 15 compared with providing the function setting switch 10-5 on the extender box 15. Thus, it is impossible to enlarge the display area of the display panel 9-5, and cause the display of the display panel 9-5 to be in an easily viewable.

### Embodiment 6

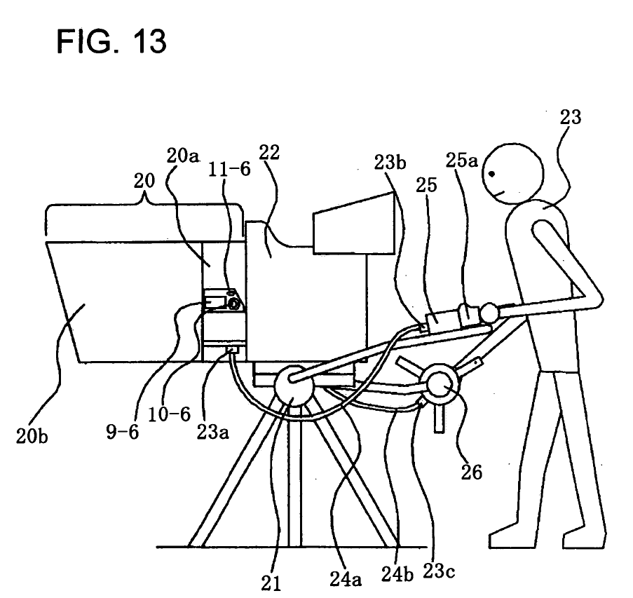

FIG. 13 is a view showing the arrangement of the box-type television lens apparatus 20 which is Embodiment 6 of the present invention when the image-taking.

In FIG. 13, the box-type television lens apparatus 20 is attached on the television camera 22 on a tripod 21 via a mount box body 20a which is provided on the box-type television lens apparatus 20. A cable 24a is connected with a connector 23a of the box-type television lens apparatus 20 side and a connector 23b of a zoom controller 25 side. Furthermore, a cable 24b is connected with a connector (not shown) of the box-type television lens apparatus 20 and a connector 23c of a focus controller 26 side. A camera man 23 operates the zoom controller 25 and the focus controller 26 to send a servo command to the CPU (not shown) in the box-type television lens apparatus 20 and control the drive control system of the box-type television lens apparatus 20. Thereby, it is possible to perform the zooming and focusing operations of the image-taking optical system.

In this embodiment, the display panel 9-6, the display switch 11-6 and the function setting switch 10-6 are provided on the mount box body 20a. The cover 20b is attached on the part other than the mount box body 20a of the box-type television lens apparatus 20 in a detachable state. As described above, the display panel 9-6 and the switches 11-6 and 10-6 are provided on the mount box body 20a, thereby the camera man can always confirm the display content of the display panel 9-6, and can operate the display switch 11-6 and the function setting switch 10-6 regardless of whether the cover 20b is attached to the box-type television lens apparatus 20 or not.

When the camera man operates an operation ring 25a provided on the zoom controller 25, it is possible to change the zooming characteristic of the image-taking optical system provided in the box-type television lens apparatus 20, for example, the change amount of the zoom speed in accordance with the operation amount of the operation ring 25a as described above explanation using FIG. 6. In this case, the operation amount (the tilt angle) of the operation ring 25a on the zoom controller 25 corresponds to the pressed amount of the seesaw switch 3 on the drive unit 2 in Embodiment 1.

### Embodiment 7

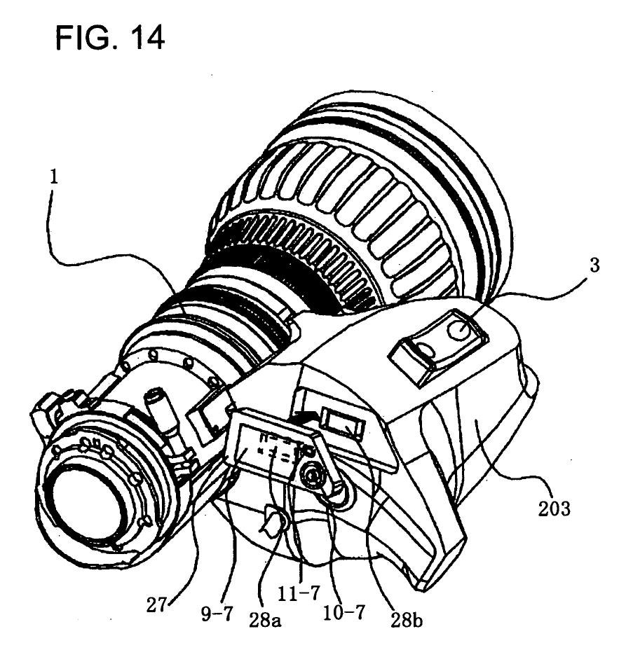

A television lens apparatus which is Embodiment 7 of the present invention will be explained with reference to FIG. 14 to 16.

In this embodiment, as shown in FIG. 14, the display panel 9-7, the display switch 11-7 and the function setting switch 10-7 are provided on one function setting unit 27 (operation apparatus). As shown in FIG. 14, a connector 28a provided on the function setting unit 27 is inserted into a connector 28b of a drive unit 203 which is attached to the lens main body 1, thereby the function setting unit 27 can be attached to the drive unit 203. Here, when the function setting unit 27 is attached to the drive unit 203, a display panel 9-7 and switches 11-7 and 10-7 are located on the camera side end face of the drive unit 203 as shown in FIG. 14. Therefore, it is possible to obtain the same effect as Embodiment 2. In FIG. 14, on the drive unit 203, the seesaw switch 3 for performing the zooming operation of the image-taking optical system provided in the lens main body 1 is provided.

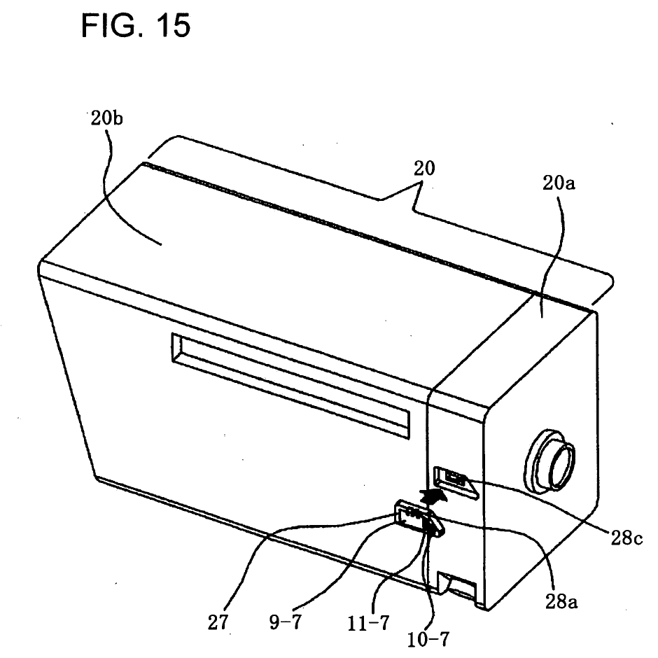

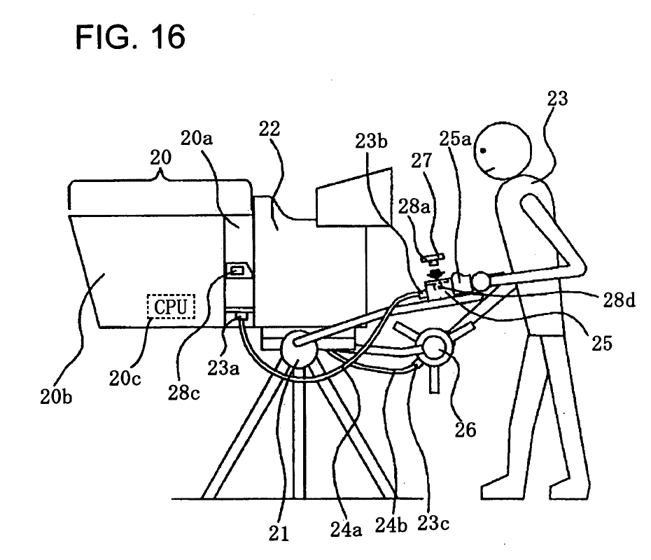

On the other hand, the connector 28a of the function setting unit 27 is inserted into a connector 28c provided on the mount box body 20a of the box-type television lens apparatus 20 shown in FIG. 15, thereby the function setting unit 27 can be attached to the box-type television lens apparatus 20 (mount box body 20a). Furthermore, the connector 28a of the function setting unit 27 is inserted into a connector 28d provided on the zoom controller 25 shown in FIG. 16, thereby the function setting unit 27 can be attached to the zoom controller 25. The same numerals as in FIG. 13 denote the same members in FIGS. 15 and 16.

When the function setting unit 27 is attached on the zoom controller 25 shown in FIG. 16, and the function setting switch 10-7 of the function setting unit 27 is operated, this operation signal is sent to a CPU 20c (driving control section) provided in the box-type television lens apparatus 20 through the cable 24a. Therefore, it is possible to change the setting of the function in the box-type television lens apparatus 20.

The function setting unit 27 having the display panel 9-7 and the function setting switch 10-7 can be attached/detached to/from one of the drive unit 203, the box-type television lens apparatus 20 and the zoom controller 25, thereby it is possible to change the arrangement of the function setting unit 27 depending on the intended purpose of the television lens apparatus. That is, when the function setting unit 27 is attached to the zoom controller 25, it is possible to operate the operation ring 25a of the zoom controller 25 while looking the display of the display panel 9-7 provided on the function setting unit 27. Furthermore, in the state shown in FIG. 16, the camera man 23 can operate the function setting switch 10-7 of the function setting unit 27 arranged at hand to easily set the function of the box-type television lens apparatus 20. Furthermore, when the function setting unit 27 is attached to the box-type television lens apparatus 20, it is possible to put away and carry the box-type television lens apparatus 20 together with the function setting unit 27. Thus, the television lens apparatus of this embodiment is convenient in usage.

Furthermore, in this embodiment, the display panel 9-7 and the function setting switch 10-7 are provided on one function setting unit 27 and the function setting unit 27 can be attached/detached to/from the drive unit 203 or the like. However, when the camera man only confirms the setting (the setting as shown in FIGS. 3, 5 and 6), only the display panel 9-7 can be detached. Furthermore, a cover member (corresponding to the rubber cover 14 in Embodiment 3) which covers the display panel 9-7 and the switches 10-7 and 11-7 may be provided on the function setting unit 27.

The attachment position of the function setting unit 27 with respect to the drive unit 203, the box-type television lens apparatus 20 and the zoom controller 25 is not confined the position shown in FIG. 14 to 16, and it may be any position. For example, the attachment position of the function setting unit 27 with respect to the drive unit may be position shown in FIG. 1 or 9.

In each of the embodiments which have been described above, an example in which a cross-shaped key is used as a function setting switch has been described. Any setting switch such as a jog shuttle switch or the like will be used as long as functions can be set along the display flow of the display panel.

In addition, the display content of the display panel is not limited to the display of the set condition of the function. The display panel can display the information (information concerning the condition of the device for image-taking) concerning the position of the focus lens, the zoom lens and the stop in addition to the information concerning the set condition of the function.

Furthermore, in each of the aforementioned embodiments, the display panel and the function setting switch are provided on the drive unit. The display panel and the function setting switch may be located at any position of the television lens apparatus comprising the lens main body and the drive unit.

It is possible to consider a case where the function setting switch and the display panel are separately connected to the drive unit via a cable as an accessory. However, in the television image-taking, the image-taking equipment is settled on the tripod (see FIG. 13) or is supported on the shoulder of the camera man (see FIG. 7) in accordance with the image-taking situation. The camera man desires that he carry the least required image-taking equipment to the spot in consideration of the mobility. Then, the camera man desires that the aforementioned function setting switch and display panel are constantly provided on the television lens apparatus in stead of using the aforementioned function setting switch and display panel as an accessory. As compared with using the function setting switch and display panel as an accessory, there is an advantage in that the total cost can be suppressed in this embodiments of the present invention.

According to the above described embodiments, each kind of setting situation can be instantly grasped when the driving of the television lens apparatus is controlled, and the setting excellent in operation is enabled. Thus, the television lens apparatus which is excellent in usability can be realized.

What is claimed is:

1. An operation apparatus which is used with a device for image-taking; comprising:
a display member which displays an information concerning a function of the device; and
a first operation switch for setting the function according to the information displayed on the display member.

2. The operation apparatus according to claim 1, wherein
the operation apparatus can be attached to the device.

3. The operation apparatus according to claim 2, wherein
the display member displays an information concerning the condition of the device.

4. The operation apparatus according to claim 2, wherein
the device is a lens apparatus which has an optical adjusting member, and the operation apparatus is a drive unit which controls the driving of the optical adjusting member.

5. The operation apparatus according to claim 4, wherein
the display member and the first operation switch are provided on the hold surface of the drive unit.

6. The operation apparatus according to claim 2, wherein
the device is a lens apparatus which has an optical adjusting member, and the operation apparatus can be attached to a drive unit which controls the driving of the optical adjusting member.

7. The operation apparatus according to claim 2, wherein
the device is a lens apparatus which has an optical adjusting member, and the operation apparatus is a drive unit which has a second operation switch for driving the optical adjusting member,
by operating the first operation switch, a parameter which decides the relationship between the driving speed of the optical adjusting member and the operation amount of the second operation switch can be set.

8. The operation apparatus according to claim 2, wherein
at least the display member is provided on the top surface of the operation apparatus.

9. The operation apparatus according to claim 2, wherein
at least the display member is provided on the surface of opposite side to an object side of the operation apparatus.

10. The operation apparatus according to claim 2, further comprising;
a cover member which covers at least one of the display member and the first operation switch.

11. The operation apparatus according to claim 2, wherein
the device is a demand which connects a lens apparatus having an optical adjusting member and a driving control section controlling the driving of the optical adjusting member and outputs a command signal to the driving control section, and
the operation apparatus can be attached to the demand.

12. The operation apparatus according to claim 2, wherein
the device is a lens apparatus which has an optical adjusting member and a driving control section controlling the driving of the optical adjusting member, and
the operation apparatus can be attached to the lens apparatus.

13. The operation apparatus according to claim 1,
the operation apparatus has a function in which at least one of a plurality of functions having the device is allocated to a third operation switch provided on the operation apparatus.

14. The operation apparatus according to claim 13, wherein
the display member displays an information concerning a condition of the device.

15. The operation apparatus according to claim 13, wherein
at least one of the functions is a cancellation of the operation of the third operation switch.

16. The device for image-taking, comprising;
the operation apparatus according to claim 1; and
an optical adjusting member.

17. The device for image-taking according to claim 16, wherein
the device is a lens apparatus which can be attached to a camera through a mount,
the display member and the first operation switch are provided on the mount.
